(19) United States
(12) Patent Application Publication
(10) Pub. No.: US 2024/0288687 A1
(43) Pub. Date: Aug. 29, 2024

(54) OPTICAL MODULE COMPRISING A CAMERA AND AN OPAQUE ELEMENT FOR ABSORBING LIGHT

(71) Applicant: VALEO VISION, Bobigny (FR)

(72) Inventors: Christophe GRARD, Bobigny Cedex (FR); Christian TEXIER, Bobigny Cedex (FR); Gregory PLANCHE, Bobigny Cedex (FR); Pierre RENAUD, Bobigny Cedex (FR)

(73) Assignee: VALEO VISION, Bobigny (FR)

(21) Appl. No.: 18/565,375

(22) PCT Filed: Jun. 1, 2022
(86) PCT No.: PCT/EP2022/064854

§ 371 Date: Nov. 29, 2023

(30) Foreign Application Priority Data
Jun. 25, 2021 (FR) FR2106863

(51) Int. Cl. G02B 27/00; G02B 5/00

(52) U.S. Cl. CPC G02B 27/0018; G02B 5/003

(57) ABSTRACT

An optical module for a vehicle includes a camera including a set of optical lenses, a housing configured to receive the camera, and a glass pane arranged facing the camera and configured to conceal the camera from the outside of the vehicle. The optical module further includes an opaque element configured to absorb light from outside said vehicle so as to reduce stray reflections of the light on the set of optical lenses of the camera.

The present invention relates to an optical module for a vehicle. It is particularly, but non-limitingly, applicable to motor vehicles.

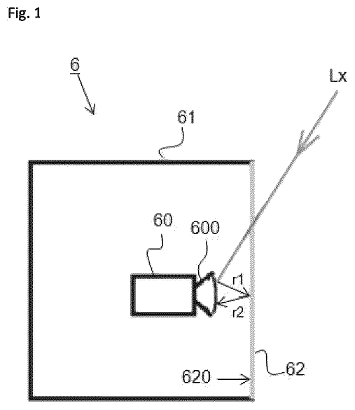

As shown in FIG. 1, an example, known to those skilled in the art, of an optical module 6 for a vehicle comprises:
a camera 60 comprising a set of optical lenses 600,
a housing 61 configured to receive said camera 60,
an outer lens 62 placed facing said camera 60.

The outer lens 62 is opaque, which allows the camera 60 to be concealed from outside the vehicle. Thus, an observer outside the vehicle does not see the camera 60 when looking at the optical module 6. The camera 60 is used to monitor the external environment of the vehicle. It generates images of the external environment of the vehicle, images which help the driver of the vehicle in particular when parking said vehicle. The vehicle displays the images from the camera 60 on its on-board screen.

One disadvantage of this prior art is that light Lx arriving from outside the vehicle, in particular light coming from above, is reflected on the set of optical lenses 600 toward the inner surface 620 of the outer lens 62, thus creating primary reflections r1 as shown in FIG. 1. These primary reflections r1 are reflections of order 1. These primary reflections r1 are in turn reflected on the inner surface 620 of said outer lens 62 and thus create secondary reflections r2 which are returned to the set of opaque lenses 600 as shown in FIG. 1. These secondary reflections r2 are reflections of order 2. These secondary reflections r2 create a parasitic diffusion of light Lx inside the set of optical lenses 600, referred to as flare. The driver will see these secondary reflections r2 on the images generated by the camera 60, which will be visually bothersome for said driver looking at the images from the camera 60 on the on-board screen. This will make it difficult for them to park the vehicle.

In this context, the present invention aims to provide an optical module that allows the aforementioned drawback to be overcome.

To this end, the invention proposes an optical module for a vehicle, said optical module comprising:
a camera comprising a set of optical lenses,
a housing configured to receive said camera,
an outer lens placed facing said camera, configured to conceal said camera from outside said vehicle, characterized in that said optical module further comprises an opaque element configured to absorb light coming from outside said vehicle in such a way as to reduce parasitic reflections of said light on said set of optical lenses of said camera.

According to non-limiting embodiments, said optical module may furthermore comprise one or more of the following additional features, implemented alone or in any technically possible combination.

According to one non-limiting embodiment,

According to one non-limiting embodiment,

According to one non-limiting embodiment, said parasitic reflections come from reflections of light on an internal surface of said outer lens.

According to one non-limiting embodiment, said opaque element is said outer lens, said outer lens comprising a first part and a second part and being opaque in a non-homogeneous manner.

According to one non-limiting embodiment, said first part of said outer lens is more opaque than said second part.

According to one non-limiting embodiment, said first part is darker than the second part.

According to one non-limiting embodiment, said first part has a thickness greater than said second part.

According to one non-limiting embodiment, said first part is made of a material that absorbs more light than the material of said second part.

According to one non-limiting embodiment, said first part of said outer lens is between 30% and 50% opaque.

According to one non-limiting embodiment, said second part of said outer lens is between 75% and 80% transparent.

According to one non-limiting embodiment, said first part of said outer lens is arranged at an angle greater than or equal to 11° relative to an optical axis of said camera.

According to one non-limiting embodiment, said first part of said outer lens is arranged at an angle greater than or equal to 21° relative to an optical axis of said camera.

According to one non-limiting embodiment, said opaque element is an opaque cap positioned protruding from the housing of said camera.

According to one non-limiting embodiment, said opaque element is an opaque cap positioned above said set of optical lenses of the camera.

According to one non-limiting embodiment, said housing comprises a non-reflective inner surface.

According to one non-limiting embodiment, said light is natural light or light from a street light.

According to one non-limiting embodiment, said first part of said outer lens is between 30% and 50% opaque and said second part of said outer lens is between 75% and 80% transparent.

According to one non-limiting embodiment, said first part of said outer lens is 50% opaque and said second part of said outer lens is 80% transparent.

According to one non-limiting embodiment, said first part of said outer lens is opaque in a variable manner.

According to one non-limiting embodiment, said first part of said outer lens has a thickness greater than 2 mm and said second part has a thickness substantially equal to 2 mm.

According to one non-limiting embodiment, the first part is arranged at an angle of between 11° and 25° relative to an optical axis of said camera.

The invention and the various applications thereof will be better understood on reading the following description and studying the accompanying figures, in which:

FIG. 1 is a schematic view of an optical module for a vehicle, said optical module comprising a camera, a housing for said camera, and an outer lens, according to the prior art,

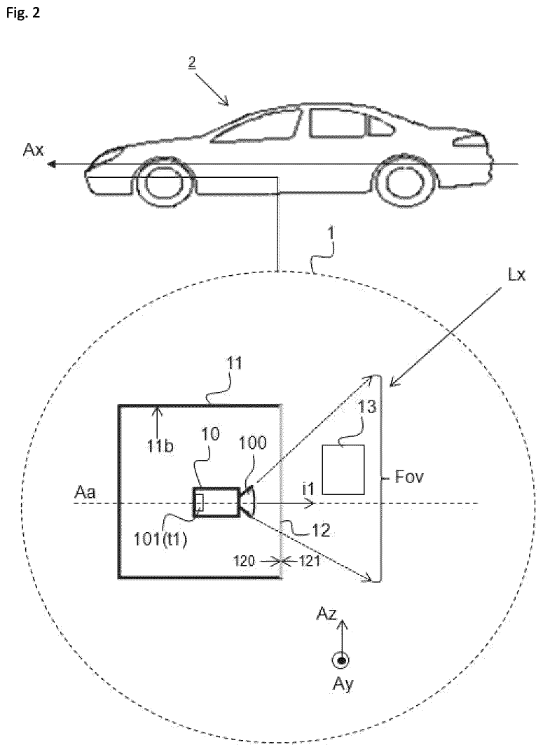

FIG. 2 is a schematic view of an optical module for a vehicle, said optical module comprising a camera, a housing for said camera, an outer lens, and an opaque element, according to the invention,

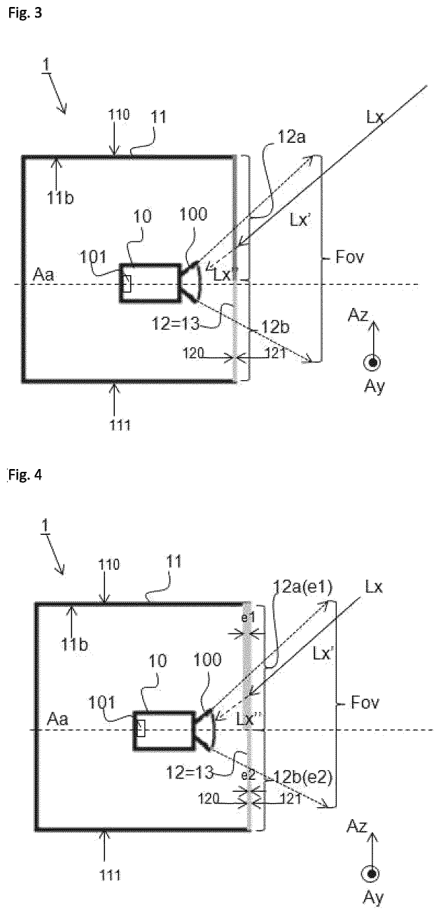

FIG. 3 is a schematic side view of an optical module of FIG. 2, according to a first alternative embodiment of a first non-limiting embodiment according to which said outer lens and said opaque element are combined,

FIG. 4 is a schematic side view of an optical module of FIG. 2, according to a second alternative embodiment of a first non-limiting embodiment according to which said outer lens and said opaque element are combined,

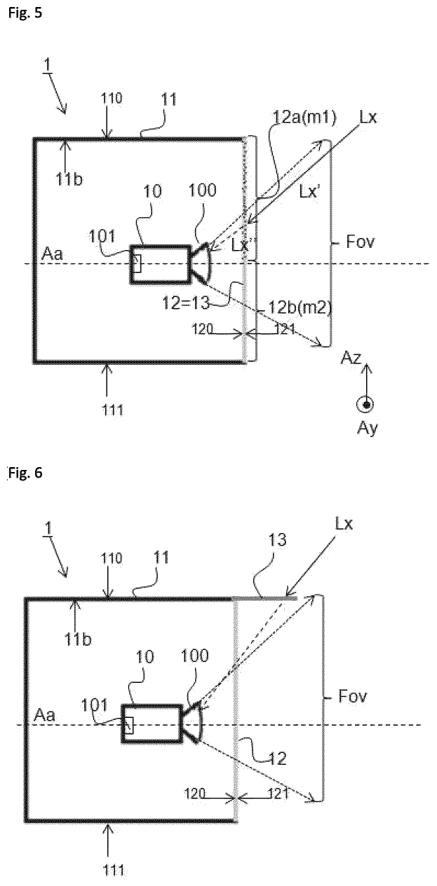

FIG. 5 is a schematic side view of an optical module of FIG. 2, according to a third alternative embodiment of a first non-limiting embodiment according to which said outer lens and said opaque element are combined,

FIG. 6 is a schematic side view of an optical module of FIG. 2, according to a first alternative embodiment of a second non-limiting embodiment according to which said outer lens and said opaque element are separate elements,

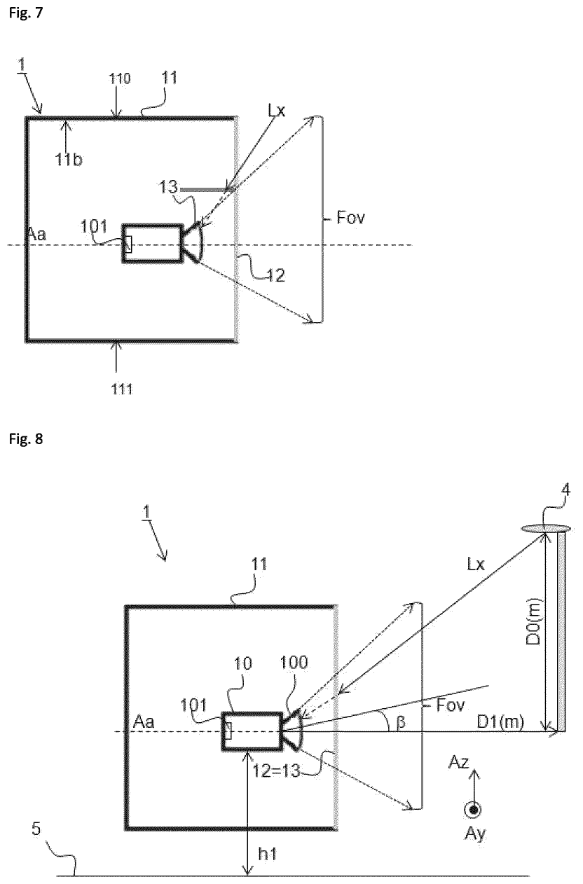

FIG. 7 is a schematic side view of an optical module of FIG. 2, according to a second alternative embodiment of a second non-limiting embodiment according to which said outer lens and said opaque element are separate elements,

FIG. 8 is a schematic side view of an optical module of FIG. 2, said optical module being arranged at a distance from a street light, according to one non-limiting embodiment;

Elements that are identical in terms of structure or function and that appear in various figures retain the same references, unless indicated otherwise.

The optical module 1 for a vehicle 2 according to the invention is described with reference to FIGS. 2 to 8. In one non-limiting embodiment, the vehicle 2 is a motor vehicle. A motor vehicle is understood to mean any type of motorized vehicle. This embodiment is taken as a non-limiting example throughout the remainder of the description. In the remainder of the description, the vehicle 2 is thus otherwise referred to as a motor vehicle 2.

As shown in FIG. 2, the optical module 1 for a motor vehicle 2 comprises:
a camera 10,
a housing 11,
an outer lens 12, and
an opaque element 13.

The camera 10 comprises a set of optical lenses 100. Said set of optical lenses 100 includes one or more optical lenses. The camera 10 has a field of view Fov. The camera 10 generates images i1 of the external environment of the motor vehicle 2. In other words, it generates images i1 relating to a scene in the external environment. The camera 10 thus detects moving objects such as other vehicles, pedestrians, bicycles, etc. or static objects such as sidewalks, road markings, buildings, trees, etc. The images i1 are displayed on the dashboard of the motor vehicle 2 and allow the driver of the motor vehicle 2 to carry out maneuvers for parking said motor vehicle 2, in one non-limiting example. In another non-limiting example, the images i1 allow the driver to see at an intersection the vehicles which may come from the right and the left, in order to determine whether they can cross the intersection safely or not. In another non-limiting example, the images i1 are images from a reversing camera. They thus make it possible to see pedestrians who are behind the motor vehicle 2 and thus allow the driver to carry out a reversing maneuver in complete safety without running over pedestrians. The camera 10 further comprises optical sensors 101 associated with the optical lenses 100, said optical sensors 101 having an integration time t1. The integration time t1 is the opening time of the cell of the optical sensor 101.

In one non-limiting embodiment, the camera 10 is an HDR, or “High Dynamic Range”, camera and has multiple integration times t1. An HDR camera makes it possible, using three images of a scene captured at the same time, specifically with a different integration time t1, to reconstruct and thus generate a single final image without noise. This also improves the light contrast of the final image so as to have more detail in the final image.

In one non-limiting embodiment, the camera 10 is a wide-angle camera. In one non-limiting example, the camera 10 has a total horizontal angle of 170° relative to the vehicle axis Ax. In non-limiting embodiments, the camera 10 is placed at the front, at the rear or on one side of said motor vehicle 2. In non-limiting embodiments, the camera 10 is positioned:
on a logo at the front of the motor vehicle 2, or
in a front headlamp, or
in a tail lamp, or
on the rear bumper, or
on a rear-view mirror.

The housing 11 is configured to receive the camera 10. It is closed off by the outer lens 12. In one non-limiting embodiment, the inner surface 11b of the housing 11 is black and non-reflective. In order to be non-reflective, it is, in one non-limiting embodiment, covered with a matte paint. This makes it possible to conceal the camera 10 from outside the motor vehicle 2. Thus, an observer outside the motor vehicle 2 will not see the camera 10 if they look at the optical module 1.

The outer lens 12, otherwise referred to as a protective lens, is placed facing the camera 10. It is configured to conceal the camera 10 from outside the motor vehicle 2. The camera 10 is thus invisible to an observer outside the motor vehicle 2 looking at the optical module 1. The outer lens 12 is thus opaque. In one non-limiting embodiment, the outer lens 12 has an opacity substantially equal to 20% (in other words, a transparency substantially equal to 80%). The outer lens 12 has an internal surface 120 facing the camera 10 and an external surface 121, opposite the internal surface 120, facing the exterior of the motor vehicle 2. In one non-limiting embodiment, the outer lens 12 closes off the housing 11.

The opaque element 13 is configured to absorb light Lx coming from outside the motor vehicle 2 in such a way as to drastically reduce, or even completely eliminate, parasitic reflections (referenced r2 in FIG. 1 depicting the prior art) of said light Lx on the set of optical lenses 100 of the camera 10.

Light Lx coming from outside is otherwise referred to as external light Lx. This light Lx is natural light from the sun (otherwise referred to as zenith light), or light from a street light. It is the light which comes from above in relation to the optical axis Aa of the camera 10. In one non-limiting embodiment, the optical axis Aa of the camera 10 corresponds to the optical center of the set of optical lenses 100.

As will be seen below, the opaque element 13 is combined with or distinct from the outer lens 12. In FIG. 2, the opaque element 13 is shown schematically separated from the outer lens 12.

In a first non-limiting embodiment shown in FIGS. 3 to 5, the opaque element 13 is said outer lens 12. The opaque element 13 and said outer lens 12 are thus combined. The outer lens 12 is composed of a first part 12a, otherwise referred to as the upper part 12a, and a second part 12b, otherwise referred to as the lower part 12b, and it is opaque in a non-homogeneous manner.

In one non-limiting embodiment, the first part 12a and the second part 12b are arranged in such a way as to cover the field of view Fov of the camera 10.

The first part 12a is configured to receive the light Lx directly, while the second part 12b is configured to receive a small part of the light Lx directly or no light Lx directly. The upper part 12a is thus located above the lower part 12b along an axis Az perpendicular to the vehicle axis Ax. Note that light Lx may be reflected on the ground on which the motor vehicle 2 is located in such a way as to reach the second part 12b in particular. The second part 12b will thus receive light Lx, but mainly or even completely indirectly via reflections thereof on the ground. Note that reflections from the ground create little flare. Thus, the sources of these reflections are the street light and the sun. Another source may be other cars.

In one non-limiting embodiment, the upper part 12a thus extends from the top 110 of the housing 11 to approximately mid-height of the camera 10, in other words to approximately the optical axis Aa of the camera 10; and the lower part 12b extends from the bottom 111 of the housing 11 to approximately mid-height of the camera 10, in other words to approximately the optical axis Aa of the camera 10.

In one non-limiting embodiment, the upper part 12a and the lower part 12b are flat.

As shown in FIG. 8, in one non-limiting embodiment, the camera 10 focuses up to a maximum viewing distance D1 of 20 meters. In the worst case, the camera 10 can be dazzled by light Lx coming from a street light 4 shown in FIG. 8, at an angle β=Arc tan(D2/D1), with D2=size of the street light 4 minus the height h1 of the camera 10 relative to the ground 5. In a non-limiting exemplary embodiment, the camera 10 is arranged at a height h1 of 1 meter relative to the ground 5. This is the case of a camera 10 for panoramic vision referred to as a “surround view camera”. In one non-limiting embodiment, the street light 4 has a size D0 of between 5 m and 9 m in height. Therefore, β=Arc tan(4/20)=11° with 4=5 meters minus 1 meter. Thus, in one non-limiting embodiment, the first part 12a is arranged at an angle β greater than or equal to 11° relative to the optical axis Aa of the camera 10. That is, the lower end of the first part 12a stops above an angle β of 11°.

Note that the illuminance of a street light 4 is approximately 500 lux, or a light intensity of 40 500 cd (candela) in the case of a street light 5 m high. At a viewing distance D1 of 20 meters, the illuminance will be approximately equal to 100 lux, which is very low. On the other hand, at a viewing distance D1 of 10 meters, the illuminance will be around 250 lux. The light Lx coming from such a street light 4 will thus cause a stronger flare effect at a viewing distance D1=10 m than at a viewing distance D1=20 m. Moreover, in another non-limiting embodiment, the first part 12a is arranged at an angle β greater than or equal to 21° relative to the optical axis Aa of the camera 10.

In one non-limiting embodiment, the first part 12a is arranged at an angle β of between 11° and 25° relative to the optical axis Aa of the camera 10.

The first part 12a of the outer lens is more opaque than the second part 12b and therefore absorbs more light Lx, whereas the second part 12b is more transparent and therefore lets in more light Lx reflected on the ground in particular, and more direct light Lx if it receives same.

In one non-limiting embodiment, the first part 12a is between 30% and 50% opaque (in other words between 70% and 50% transparent), while the second part 12b is between 75% and 80% transparent (in other words between 20% and 25% opaque). In a non-limiting alternative embodiment, the first part 12a is 50% opaque (in other words 50% transparent) and the second part is 80% transparent (in other words 20% opaque). This means that the first part 12a blocks the light Lx to 50% and the second part 12b lets through 80% of the light Lx arriving on the optical module 10.

In one non-limiting embodiment, the first part 12a is opaque in a variable manner. Thus, in one non-limiting example, the opacity of the first part 12a may gradually increase from bottom to top, in other words from the end which is located close to the optical axis Aa of the camera 10 up to the end which is located close to the top 110 of the housing 11. Likewise, in one non-limiting embodiment, the second part 12b is transparent in a variable manner. Thus, in one non-limiting example, the transparency of the second part 12b may gradually increase from top to bottom, in other words from the end which is located close to the optical axis Aa of the camera 10 up to the end which is located close to the bottom 111 of the housing 11.

The upper part 12a absorbs light Lx such that it only partially passes through the outer lens 12 at this level and such that there are very few parasitic reflections, or even none at all, on said internal surface 120 of said outer lens 12 which disrupt the images i1 from the camera 10. As shown in FIGS. 3 to 5, the upper part 12a absorbs the majority Lx′ of the light Lx and lets a small part Lx″ pass through. The upper part 12a also considerably reduces or even eliminates other parasitic reflections, which are other secondary reflections on the set of optical lenses 100 and which come from reflections of the external light Lx inside the outer lens 12, in other words directly on its internal surface 120, and which are returned to the set of optical lenses 100.

Three non-limiting alternative embodiments are described below for making the first part 12a of the outer lens 12 more opaque compared to the second part 12b.

In a first non-limiting alternative embodiment shown in FIG. 3, the first part 12a is darker than the second part 12b. This makes it more opaque. Note that to make the first part 12a darker than the second part 12b, in an industrial process, in one non-limiting embodiment, the upper part 12a is darkened. Thus, instead of being at 20% opacity, the upper part 12a will be 30% opaque in one non-limiting example. In another non-limiting embodiment, the lower part 12b is made clearer. Thus, instead of being 70% transparent as for the upper part 12a, the lower part 12b will be 90% transparent in one non-limiting example. To make the upper part 12a darker, in one non-limiting example, a tinted paint may be used. In another non-limiting example, a 2K or 3K multi-shot injection molding process may be used.

In a second non-limiting alternative embodiment shown in FIG. 4, the first part 12a has a thickness e1 greater than the thickness e2 of said second part 12b. Thickening the material of the first part 12a makes it more opaque and it thus absorbs more light Lx. In one non-limiting embodiment, the thickness e1 is greater than 2 mm. In one non-limiting embodiment, it is equal to 3 mm to obtain an opacity of 50%. In one non-limiting embodiment, the thickness e2 is substantially equal to 2 mm.

Note that a material absorbs light according to a linear absorption coefficient α such that P=P0×exp(−α×e) with e the thickness of the material, in this case e=e1 the thickness of the material of the first part 12a, P the luminous power of the light Lx, and P0 an initial light power. Thus, α=(4×π×k)/λ with λ the wavelength of the light Lx, and k the extinction coefficient which is intrinsic to the material of the first part 12a. k depends on the refractive index and the permittivity of the material. As the formulation of k is known to those skilled in the art, k is not described herein.

In a third non-limiting alternative embodiment shown in FIG. 5, the first part 12a is made of a material m1 which absorbs more light Lx than the material m2 of said second part 12b. In one non-limiting example, the lower part 12b is made of a PMMA (polymethyl methacrylate) or PC (polycarbonate) material. In one non-limiting example, the upper part 12a is made of a PMMA or PC material with more colored pigments (illustrated by dots) inside, which will absorb light Lx and thus make it more opaque.

In a second non-limiting embodiment shown in FIGS. 6 and 7, the opaque element 13 is different from said outer lens 12 and is an opaque cap. They are thus not combined. In this second non-limiting embodiment, in one non-limiting example, the outer lens 12 is 20% opaque and thus lets in 80% of the light Lx coming from outside the motor vehicle 2. In one non-limiting embodiment, the opaque cap 13 is flat. The opaque cap 13 is arranged so as not to obstruct the field of view Fov of the camera 10.

In a first non-limiting alternative embodiment shown in FIG. 6, the opaque cap 13 is positioned protruding from the housing 11 of the camera 10. It extends parallel to the optical axis Aa of the camera 10 and from the top 110 of the housing 11. As can be seen, the opaque cap 13 absorbs light Lx. It absorbs light in part or in full. This depends on its opacity. In the non-limiting example shown, it absorbs light in full. In one non-limiting example, the opaque cap 13 is adhesively bonded to the housing 11.

In a second non-limiting alternative embodiment shown in FIG. 7, the opaque cap 13 is positioned above said set of optical lenses 100 of the camera 10. It extends parallel to the optical axis Aa of the camera 10. As can be seen, the opaque cap 13 absorbs light Lx. It absorbs light in part or in full. This depends on its opacity. In the non-limiting example shown, it absorbs light in full. In one non-limiting embodiment of this second non-limiting alternative embodiment, the opaque cap 13 is placed against the outer lens 12. In one non-limiting example, it is adhesively bonded to the outer lens 12.

Note that in a camera without an opaque element 13, the darker a scene is, the longer the integration time t1 must be to capture and generate an image i1 of said scene, and the brighter a scene is, the shorter the integration time t1 must be. Furthermore, without an opaque element 13, it takes several integration times t1 to arrive at a final image i1 having a strong contrast between the various areas of the image in which the details in all areas of the scene captured can be clearly seen. For example, it takes a short integration time t1 to capture clouds in the sky lighter than the road (the dark elements of the image are darkened), and it takes a long integration time t1 to capture bumps on the road darker than the sky (the sky is saturated, and thus becomes almost completely white).

In an image i1, the light intensity of the scene is greater toward the top (at sky level) than the part at the optical axis Aa of the camera 10 or toward the ground. The opaque element 13 makes it possible to compensate for this difference in light intensity. The light intensity becomes more uniform across the entire image i1 generated by the camera 10. The opaque element 13 makes it possible to darken the top of the image i1. Instead of using several integration times t1, with a single integration time t1, in the image i1, it is possible to clearly see the details in all areas of the image i1, particularly at the top of the scene captured and also at the bottom of the scene captured. The contrast between the various elements in the image i1 is thus reduced with the opaque element 13.

Note also that in a camera without an opaque element 13, by increasing the contrast in the image i1, the signal-to-noise ratio of the optical sensors 101 is reduced. To be specific, without an opaque element 13, for a given integration time t1, an image is obtained with more quantification errors toward the extremes of light intensity. With the opaque element 13, the signal-to-noise ratio is increased because the quantification noise at the extremes of light intensity is reduced. There is therefore no need for conventional HDR with more than one image with different integration times t1.

Thus, with the opaque element 13, the contrast of the image i1 is reduced and the signal-to-noise ratio is increased, which makes it possible to see more details in the image i1. Thus, the driver viewing the images i1 from the camera 10 will see the details more clearly, which will make it easier to maneuver when parking, for example.

Of course, the description of the invention is not limited to the embodiments described above and to the field described above. Thus, in one non-limiting embodiment, the set of optical lenses 100 may be treated with an anti-reflective treatment. Thus, in another non-limiting embodiment, instead of extending from the top of the housing 11 to approximately mid-height of the camera 10, the upper part 12a may extend from the top 110 of the housing 11 to ⅓ of the camera 10.

Thus, the invention described has the following advantages in particular:
it makes it possible to considerably reduce, or even eliminate, parasitic reflections on the set of optical lenses, parasitic reflections caused by light Lx; it thus makes it possible to reduce or even eliminate flare so that it is no longer bothersome for the driver of the vehicle 2 when viewing the images from the camera,
it makes it possible to conceal the camera 10 from an observer looking at the optical module 1 from outside the motor vehicle 2,
it makes it possible to obtain a more homogeneous image and therefore to reduce the contrast in an image i1 and thus to obtain better image rendering quality,
it makes it possible to increase the signal-to-noise ratio, particularly in the dark parts which are generally located toward the bottom of an image i1.

1. An optical module for a vehicle, said optical module comprising:
a camera comprising a set of optical lenses,
a housing configured to receive said camera,
an outer lens placed facing said camera, configured to conceal said camera from outside said vehicle, wherein said optical module further comprises an opaque element configured to absorb light coming from outside said vehicle in such a way as to reduce parasitic reflections of said light on said set of optical lenses of said camera.

2. The optical module as claimed in claim 1, wherein said parasitic reflections come from reflections of light on an internal surface of said outer lens.

3. The optical module as claimed in claim 1, wherein said opaque element is said outer lens, said outer lens comprising a first part and a second part and being opaque in a non-homogeneous manner.

4. The optical module as claimed in claim 3, wherein said first part of said outer lens is more opaque than said second part.

5. The optical module as claimed in claim 4, wherein said first part is darker than the second part.

6. The optical module as claimed in claim 4, wherein said first part has a thickness greater than said second part.

7. The optical module as claimed in claim 4, wherein said first part is made of a material that absorbs more light than the material of said second part.

8. The optical module as claimed in claim 4, wherein said first part of said outer lens is between 30% and 50% opaque.

9. The optical module as claimed in claim 4, wherein said second part of said outer lens is between 75% and 80% transparent.

10. The optical module as claimed in claim 3, wherein said first part of said outer lens is arranged at an angle greater than or equal to 11° relative to an optical axis of said camera.

11. The optical module as claimed in claim 3, wherein said first part of said outer lens is arranged at an angle greater than or equal to 21° relative to an optical axis of said camera.

12. The optical module as claimed in claim 1, wherein said opaque element is an opaque cap positioned protruding from the housing of said camera.

13. The optical module as claimed in claim 1, wherein said opaque element is an opaque cap positioned above said set of optical lenses of the camera.

14. The optical module as claimed in claim 1, wherein said housing comprises a non-reflective inner surface.

15. The optical module as claimed in claim 1, wherein said light is natural light or light from a street light.

16. The optical module as claimed in claim 2, wherein said opaque element is said outer lens, said outer lens comprising a first part and a second part and being opaque in a non-homogeneous manner.

17. The optical module as claimed in claim 5, wherein said first part of said outer lens is between 30% and 50% opaque.

18. The optical module as claimed in claim 5, wherein said second part of said outer lens is between 75% and 80% transparent.

19. The optical module as claimed in claim 4, wherein said first part of said outer lens is arranged at an angle greater than or equal to 11° relative to an optical axis of said camera.

20. The optical module as claimed in claim 4, wherein said first part of said outer lens is arranged at an angle greater than or equal to 21° relative to an optical axis of said camera.
